(19) United States
(12) Patent Application Publication
(10) Pub. No.: US 2005/0232790 A1
(43) Pub. Date: Oct. 20, 2005

(54) Linear compressor

(75) Inventor: Jong Rea Park, Seoul (KR)

Correspondence Address: Ladas & Parry, 26 West 61th Street, New York, NY, 10023, US

(73) Assignee: SAMSUNG GWANGJU ELECTRONICS CO., LTD.

(21) Appl. No.: 10/932,442

(22) Filed: Sep. 2, 2004

(30) Foreign Application Priority Data
Apr. 19, 2004 (KR) 2004-26854

(51) Int. Cl. F02B 75/18

(52) U.S. Cl. 417/410.1; 417/437

(57) ABSTRACT

A linear compressor comprising a cylinder block molded through insert molding of an inner core. In a state wherein a plurality of steel plates, constituting the inner core, are circumferentially arranged inside a mold, into the mold is injected a nonmagnetic molten material, such as aluminum, etc. As the molten material is solidified, the cylinder block, to which the inner core is firmly fixed, is completed.

### CROSS-REFERENCE TO RELATED APPLICATION

This application claims the benefit of Korean Patent Application No. 2004-26854, filed on Apr. 19, 2004 in the Korean Intellectual Property Office, the disclosure of which is incorporated herein by reference.

### BACKGROUND OF THE INVENTION

1. Field of the Invention

The present invention relates to linear compressors, and, more particularly, to linear compressors comprising an inner core inwardly located with respect to a mover for driving a piston, and a cylinder block coupled with the inner core.

2. Description of the Related Art

Generally, in a refrigeration cycle wherein compression, condensation, expansion, and evaporation processes are continuously performed using a refrigerant, compressors serve to compress the refrigerant, and discharge it to the outside. One kind of such compressors is linear compressors wherein a linear motor, exhibiting a rectilinear motion, is used to reciprocate a piston for compressing a refrigerant.

Conventional linear compressors comprise a compressing unit for compressing a refrigerant, and a driving unit for providing power to the compressing unit. Both the compressing unit and the driving unit are installed inside a hermetic casing.

The compressing unit, for compressing the refrigerant, includes a cylinder block defining a compression chamber, and a piston reciprocating inside the compression chamber.

The driving unit includes an inner core surrounding the outside of the cylinder block, an outer core externally spaced apart from the inner core by a prescribed distance so that it surrounds the outer circumference of the inner core, the outer core having a coil wound therein, and a mover interposed between the inner and outer cores so that it reciprocates for driving the piston through electromagnetic interaction with the inner and outer cores.

Meanwhile, the conventional linear compressors further comprise a holder for maintaining a cylindrical shape of the inner core for allowing the inner core to be installed to the cylinder block. As the holder is fastened to the cylinder block by press-fitting, or by using bolts, etc., the inner core can be installed to the cylinder block.

The conventional linear compressors, however, have a problem in that they may induce deformation or damage to the cylinder block when the holder is press-fitted or bolted to the cylinder block, resulting in deterioration in compression efficiency and reliability of the compressors.

The presence of such a holder required for the installation of the inner core, further, results not only in complexity in the overall manufacturing process, but also increase in manufacturing costs.

### SUMMARY OF THE INVENTION

The present invention has been made in view of the above mentioned problems, and an aspect of the invention is to provide a linear compressor which can allow an inner core to be easily and securely fixed to a cylinder block, and can prevent deformation of the cylinder block.

In accordance with an aspect, the present invention provides a linear compressor comprising: a piston reciprocating inside a compression chamber for compressing a refrigerant; a mover for driving the piston; inner and outer cores internally and externally disposed with respect to the mover so that they electromagnetically interact with the mover, and a cylinder block molded through insert molding of the inner core, the cylinder block defining the compression chamber therein.

The inner core may have one or more grooves formed at its surfaces in contact with the cylinder block for preventing separation thereof from the cylinder block.

The inner core may have one or more protrusions formed at its surfaces in contact with the cylinder block for preventing the separation thereof from the cylinder block.

Iin the molding of the cylinder block may be used a nonmagnetic molten material.

The molten material may include aluminum.

### BRIEF DESCRIPTION OF THE DRAWINGS

The above aspect, and other features and advantages of the present invention will become more apparent after reading the following detailed description when taken in conjunction with the drawings, in which:

FIG. 1 is a sectional view illustrating the general structure of a linear compressor in accordance with the present invention;

FIGS. 2 to 4 are sectional views illustrating a manufacturing procedure of a cylinder block of the linear compressor in accordance with the present invention; and

FIGS. 5 and 6 are sectional views illustrating two different shapes of an inner core of the linear compressor in accordance with the present invention.

### DETAILED DESCRIPTION OF THE PREFERRED EMBODIMENTS

Preferred embodiments of the present invention will now be described in detail with reference to the annexed drawings.

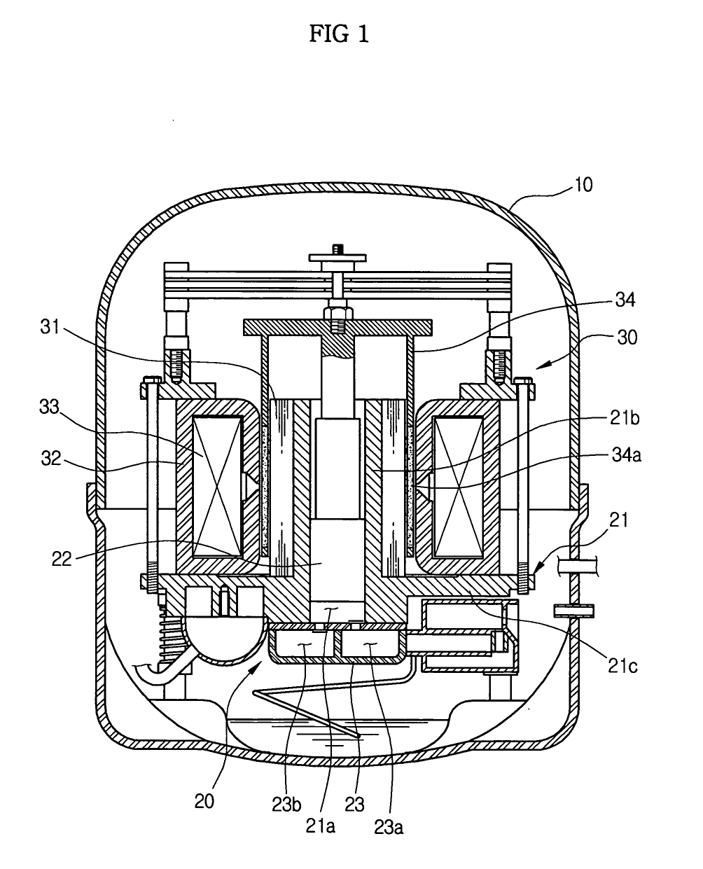

Referring to FIG. 1 illustrating a linear compressor in accordance with the present invention, it comprises, inside a hermetic casing 10, a compressing unit 20 for compressing a refrigerant, and a driving unit 30 for driving the compressing unit 20.

The compressing unit 20 includes a cylinder block 21 defining a compression chamber 21a, and a piston 22 reciprocating inside the compression chamber 21a. Coupled to one side of the cylinder block 21 is a cylinder head 23 which defines a suction chamber 23a and a discharge chamber 23b.

The driving unit 30 includes an inner core 31 surrounding the outside of the cylinder block 21, and an outer core 32 spaced apart from the outer circumference of the inner core 31 by a prescribed distance to surround the inner core 31. The outer core 32 has a coil 33 annularly wound therein for producing a magnetic field. Between the inner and outer cores 31 and 32 is interposed a mover 34, which is installed with a magnet 34a, and is adapted to reciprocate the piston 22.

Meanwhile, the cylinder block 21 has a cylindrical portion 21b internally defining the compression chamber 21a, and a supporting portion 21c radially extending from one end of the cylindrical portion 21b for supporting the outer core 32. The cylindrical portion 21b and the supporting portion 21c of the cylinder block 21 are integrally molded in a state wherein the inner core 31 is inserted therein.

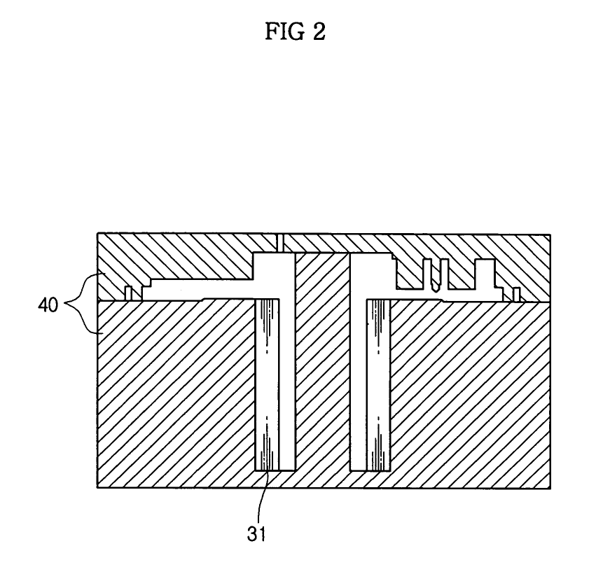

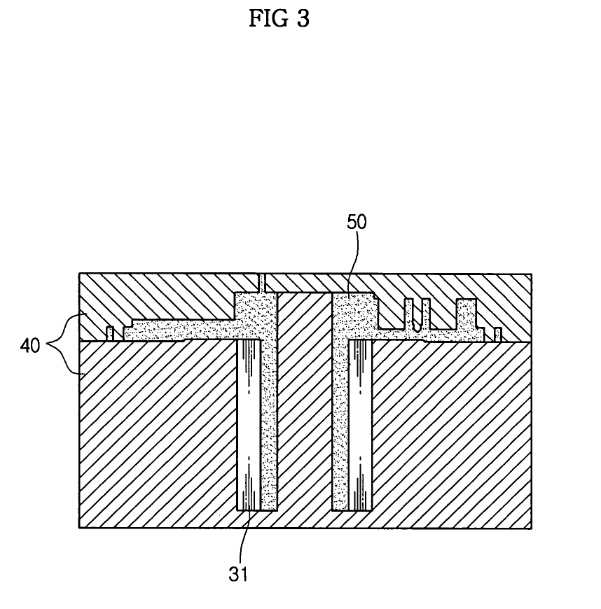

That is, as shown in FIG. 2, first, inside a mold 40, having a shape corresponding to that of the cylinder block 21, are circumferentially arranged a plurality of steel sheets so that they are spaced apart from each other by a prescribed distance. Then, as shown in FIG. 3, into the mold 40 is injected a nonmagnetic molten material 50, such as aluminum, etc.

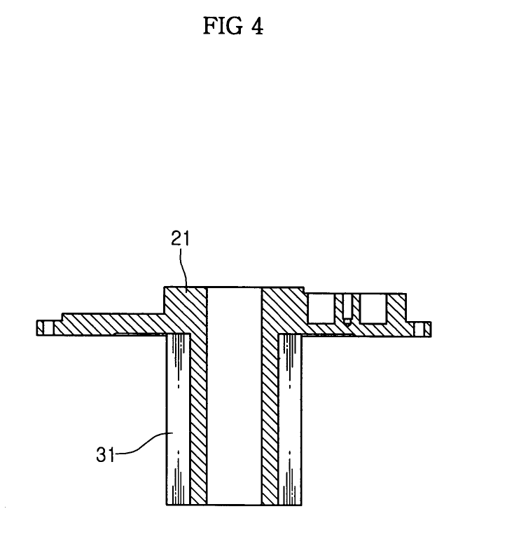

After solidification of the molten material 50, the mold 40 is removed. Thereby, as shown in FIG. 4, the cylinder block 21, to which the inner core 31 is firmly fixed, is completed.

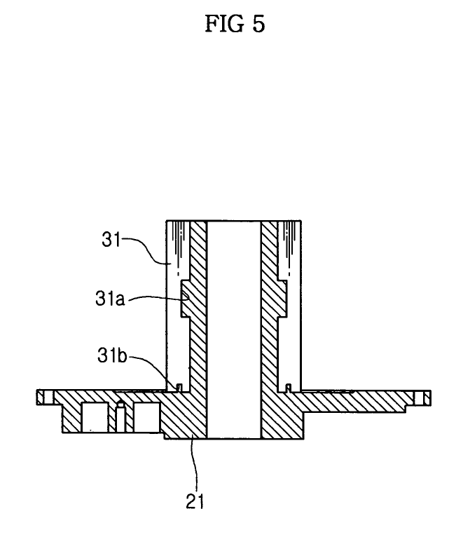

Referring to FIG. 5, the inner core 31 has one or more grooves 31a and 31b formed at its surfaces in contact with the cylinder block 21 formed by solidification of the molten material 50. In this case, one of the grooves, namely, a lateral groove 31a serves to prevent separation of the inner core 31 in a vertical direction, and the other one of the grooves, namely, a bottom groove 31b serves to prevent separation of the inner core 31 in a horizontal direction.

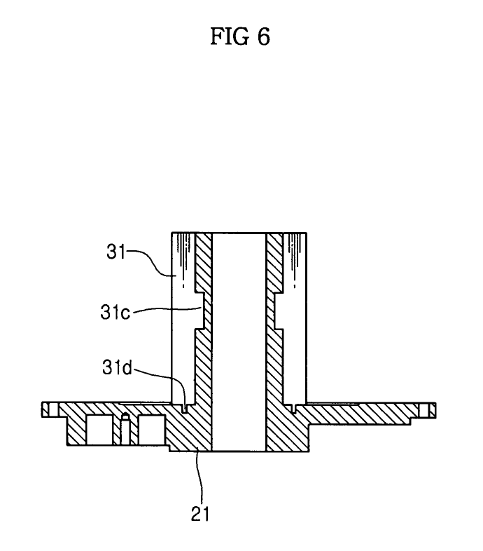

Referring to FIG. 6, in order to prevent separation of the inner core 31 from the cylinder block 21, alternatively, the inner core 31 has one or more protrusions 31c and 31d formed at its surfaces in contact with the cylinder block 21.

Now, the operation and effects of the linear compressor according to the present invention will be explained.

First, if electric power is applied to the driving unit 30, a magnetic flux is produced between the inner core 31 and the outer core 32, thereby allowing the mover 34, disposed between the inner and outer cores 31 and 32, to vertically reciprocate by electromagnetic interaction. Through such a reciprocation of the mover 34, the piston 22 reciprocates inside the compression chamber 21a, thereby compressing the refrigerant.

In this case, since the inner core 31, serving as a propagation passage of the magnetic flux, is firmly fixed to the cylinder block 21 by insert molding, the inner core 31 can be stably maintained so as not to be separated from the cylinder block 21 even if vibration caused upon driving of the compressor is applied thereto.

As apparent from the above description, the present invention provides a linear compressor wherein an inner core of a driving unit is firmly fixed to a cylinder block of a compressing unit by insert molding.

With such a configuration, the inner core can be firmly fixed without deformation or breakage of the cylinder block, resulting in improvement in reliability and compression efficiency of the compressor.

Further, the present invention can eliminate the need for separate elements and processes for fixing the inner core to the cylinder block, resulting in simplification in the overall manufacturing process and reduction in manufacturing costs.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. A linear compressor comprising:
a piston reciprocating inside a compression chamber for compressing a refrigerant;
a mover for driving the piston;
inner and outer cores internally and externally disposed with respect to the mover so that they electromagnetically interact with the mover; and
a cylinder block molded through insert molding of the inner core, the cylinder block defining the compression chamber therein.

2. The compressor according to claim 1, wherein the inner core has one or more grooves formed at its surfaces in contact with the cylinder block for preventing separation thereof from the cylinder block.

3. The compressor according to claim 1, wherein the inner core has one or more protrusions formed at its surfaces in contact with the cylinder block for preventing the separation thereof from the cylinder block.

4. The compressor according to claim 1, wherein in the molding of the cylinder block is used a nonmagnetic molten material.

5. The compressor according to claim 4, wherein the molten material includes aluminum.
